(19) United States
(12) Patent Application Publication
(10) Pub. No.: US 2023/0182849 A1
(43) Pub. Date: Jun. 15, 2023

(54) TRACKING ELEMENT PROTECTION DEVICE

(71) Applicant: PINHEAD COMPONENTS, INC., EDMONTON (CA)

(72) Inventor: LINDA YOUNG, EDMONTON (CA)

(21) Appl. No.: 17/643,899

(22) Filed: Dec. 13, 2021

(51) Int. Cl. B62J 45/42

(52) U.S. Cl. CPC B62J 45/42

(57) ABSTRACT

A tracking element protection device includes a first part, two clamp members and a second part. The first part includes a first recess, and the second part includes a second recess. A tracking element is received in the first recess. The first and second parts are connected to each other by two fasteners. The two clamp members are located between the first and second parts so as to clamp the protection device to a bicycle frame between the two clamp members. Each fastener includes a head and a threaded shank which extends through the second part and is threadedly connected a threaded hole in the first part. The head of each fastener includes three first positioning portions. A key is mounted to the head and includes three second positioning portions which are engaged with the first positioning portions to unscrew the fastener to separate the first and second parts.

### BACKGROUND OF THE INVENTION

### 1. Fields of the Invention

The present invention relates to a tracking element protection device for bicycles or vehicles, and more particularly, to a protection device secured to a bicycle or vehicle and a tracking element is accommodated in the protection device, the protection device cannot be opened except for using a correct key.

### 2. Descriptions of Related Art

Cycling becomes a popular trend in the world. However, if the bicycle parking place is large, or there are many parking vehicles, it is difficult to find your bicycle quickly, which is time-consuming. When the bicycle is lost or stolen, it is difficult to have clues to find the bicycle effectively. Nowadays, thanks to the innovative development of mobile phone technology, such as AIRTAG supported by iOS operation system, or

SMART TAG supported by Android operating system, both of which are Bluetooth tracking elements, through install the Bluetooth tracking elements to the bicycles, the users can track the Bluetooth tracking elements via their smart phones. Some of the tracking elements can buzz a sound, such that the users can find their bicycles in dark.

The current installation structure of the tracking elements is to secure a box to the bicycle, and the tracking element is received in the box. Generally, the box generally includes a base and a cover, and the box is installed to the underside of the seat, the bicycle frame or the head tube. However, the cover can be easily removed or opened relative to the base, such that the tracking element can be discarded.

Taiwanese Utility Model M608163 discloses a “Bicycle Configuration Positioning Tracker Structure”, wherein the tacking element is positioned in the bicycle frame that is made of carbon fiber composite material. The emitting end of the tracking element is positioned to a specific position of the bicycle frame, wherein the specific position of the bicycle frame is made of a material to avoid communication barrier. Accordingly, the tracking element that is integrated into the bicycle frame will not be found and damaged. Nevertheless, the shortcoming is obvious because the tracking element cannot be picked out from the bicycle frame and charged.

The present invention intends to provide a tracking element protection device to eliminate shortcomings mentioned above.

### SUMMARY OF THE INVENTION

The present invention relates to a tracking element protection device and comprises a first part having a first recess defined in the inside thereof for accommodating a tracking element therein. Two ribs respectively extend outward from two ends of the inside of the first part. Each rib includes a threaded hole. Two clamp members shaped symmetrically to each other. Each of the two clamp members includes a groove defined in the inside thereof so as to clamp a portion of a bicycle.

A second part includes a second recess defined in the inside thereof. Two through holes are defined through the second part. The second part is mounted to the first part, and the two clamp members are located between the first and second parts. The second recess is located corresponding to the first recess, and the two through holes are located corresponding to the two threaded holes.

Two fasteners respectively extend through the two through holes of the second part and are threadedly connected to the threaded holes of the first part. Each fastener includes a head and a threaded shank extending from the head. The threaded shank extends through the through hole and is threadedly connected to the threaded hole corresponding thereto. The head of each fastener is a semi-sphere head which includes at least three first positioning portions spaced apart from each other. The three first positioning portions are located not symmetrical to each other.

The primary object of the present invention is to provide a tracking element protection device that includes two fasteners to connect the first and second parts together. A correct key is required to unscrew the two fasteners to open the protection device.

The advantages of the present invention are that the protection device includes two clamp members located between the first and second parts. The tracking element is received in the first part, and the bicycle frame is clamped between the two clamp members.

The first and second parts are connected to each other by two fasteners. The head of each fastener is a semi-sphere head which includes at least three first positioning portions spaced apart from each other. The three first positioning portions are cutouts or protrusions with individual depth or length, and are located not symmetrical to each other. It is difficult for unauthorized persons to unscrew the two fasteners so as to enhance the safety features.

The user uses the key to easily separate the first and second part to access the tracking element. Therefore, the tracking element can be replaced or charged conveniently.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the tracking element protection device of the present invention;

FIG. 2 is an exploded view of the tracking element protection device of the present invention;

FIG. 3 is a top cross sectional view of the tracking element protection device of the present invention;

FIG. 4 shows that the tracking element protection device of the present invention is secured to the seat tube of a bicycle;

FIG. 5 shows that the fastener and key for unscrew the fastener of the tracking element protection device of the present invention;

FIG. 6 is an exploded view of the tracking element protection device of the present invention, wherein another type of tracking element is received in the protection device, and

FIG. 7 shows that the tracking element protection device of the present invention is secured to a motorbike.

### DETAILED DESCRIPTION OF THE PREFERRED EMBODIMENT

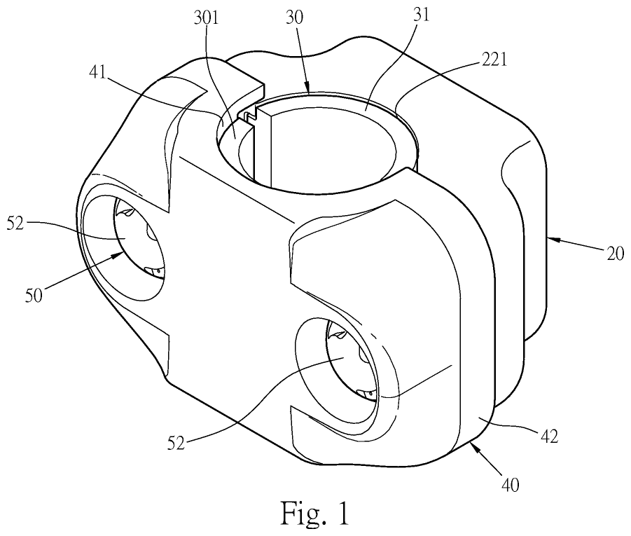

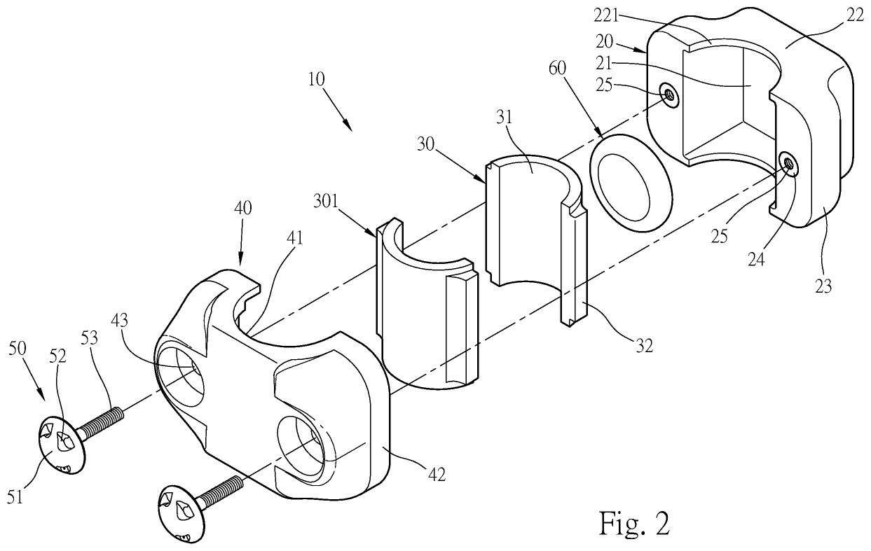

Referring to FIGS. 1 and 2, the tracking element protection device 10 of the present invention comprises a first part 20, two clamp members 30, 301 and a second part 40. The first and second parts 20, 40 are connected with each other by two fasteners 50, and the two clamp members 30, 301 are located between the first and second parts 20, 40. Two ribs 23 respectively extend outward from two ends of the inside of the first part 20. Each rib 23 includes a threaded hole 25. A first recess 21 is defined in the inside of the first part 20 and a tracking element 60 is received in the first recess 21. Specifically, the first part 20 includes two flanges 22 formed between the two ribs 23. The first recess 21 is formed between the two flanges 22 and the two ribs 23. Each first flange 22 includes a notch 221 which communicates with the first recess 21.

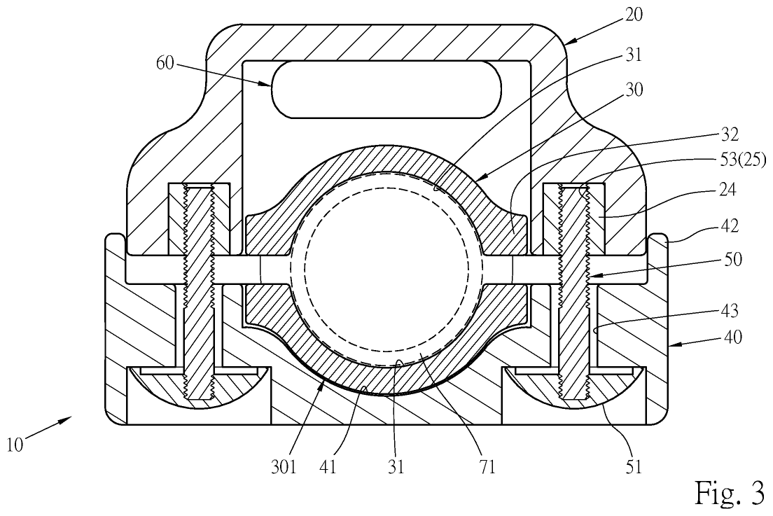

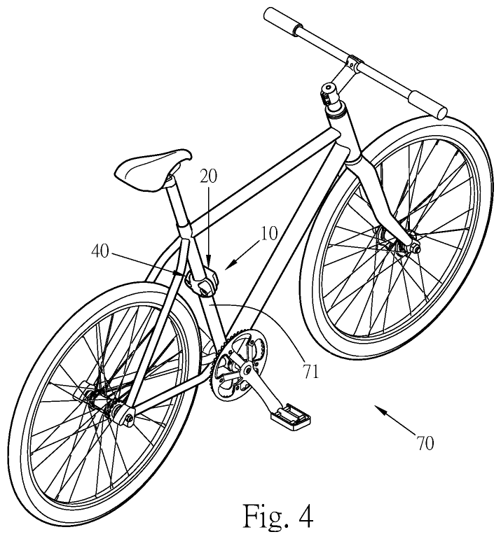

The two clamp members 30, 301 are shaped symmetrically to each other, and each of the two clamp members 30, 301 includes a groove 31 defined in the inside thereof. Each of the two clamp members 30, 301 includes two ridges 32 respectively extending outward from two sides thereof. The two respective grooves 31 form a space so as to clamp the seat tube 71 of a bicycle within the space as shown in FIGS. 3 and 4.

The second part 40 includes a second recess 41 defined in the inside thereof so that one of the two clamp members 301 is accommodated in the second recess 41 of the second part 40 as shown in FIG. 3. Two through holes 43 are defined through the second part 40 and are located corresponding to the two threaded holes 25 of the first part 20. In this embodiment, each rib 23 includes a plug 24 received therein and the threaded hole 25 is located at the center of the plug 24. The second part 40 further includes two arms 42 respectively extending from two sides thereof and toward the first part 20.

The two arms 42 are mounted to two respective outsides of the two ribs 23 when the first and second parts 20, 40 are connected to each other by the two fasteners 50 that respectively extend through the two through holes 43 of the second part 40 and are threadedly connected to the threaded holes 25 of the first part 20. Each fastener 50 includes a head 51 and a threaded shank 53 extending from the head 51. The threaded shank 53 extends through the through hole 43 and is threadedly connected to the threaded hole 25 corresponding thereto. The head 51 of each fastener 50 is a semi-sphere head which includes first positioning portions 52 that are formed along the curvature of the semi-sphere head and spaced apart from each other. The three first positioning portions 52 are located not symmetrical to each other. The three first positioning portions 52 can be three cutouts or three protrusions with individual depth or length, and the three first positioning portions 52 are located not symmetrical to each other.

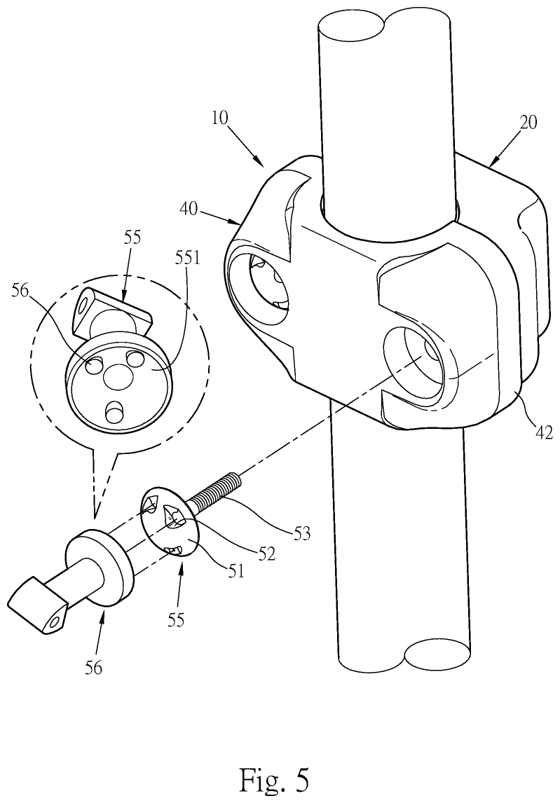

Referring to FIG. 5, the key 55 that is used to unscrew the fasteners 50 includes a skirt portion formed to one end thereof, and a chamber 551 is formed in the skirt portion. Three second positioning portions 56 are formed to the inner end or inner periphery of the chamber 551. The head 51 of each fastener 50 accommodated in the chamber 551 of the key 55. The three first positioning portions 52 and the three second positioning portions 56 are engaged with each other. The key 55 is rotated to rotate the fastener 50 such that the second part 40 is separated from the first part 20. The key 56 and the fasteners 50 are similar to applicant's former patent U.S. Pat. No. 6,341,927.

As shown in FIGS. 3, 4 and 5, when using the tracking element protection device 10 to a bicycle 70, the tracking element 60 is received in the first recess 21 of the first part 20, the two clamp members 30, 301 are mounted to the seat tube 71, and the first and second parts 20, 40 are then connected to each other by using the two fasteners 50 as mentioned above to secure the two clamp members 30, 301. The two arms 42 are located outside of the two ribs 23 to prevent foreign objects from entering into the tracking element protection device 10.

By using Bluetooth technology, the user can track the tracking element 60 by his/her smart phone, and positioning the tracking element 60 cooperated with the map of the smart phone.

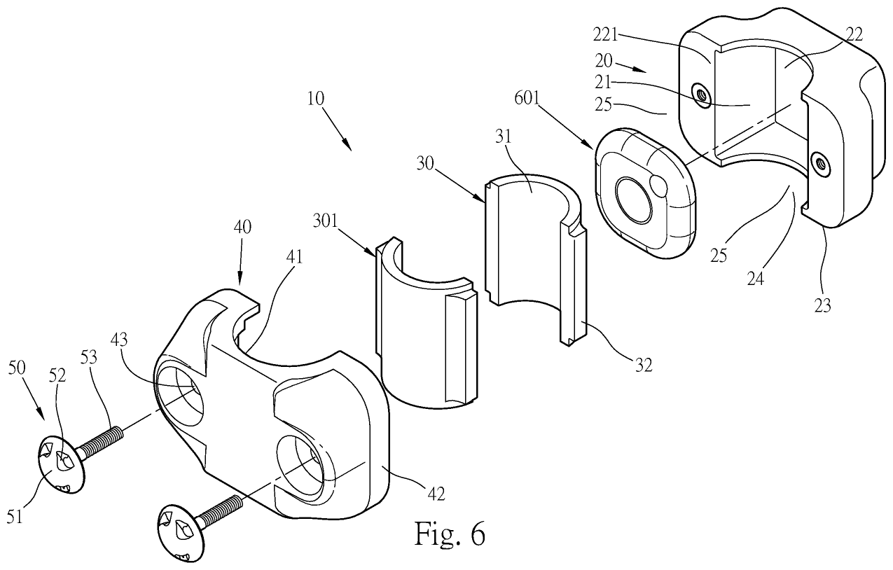

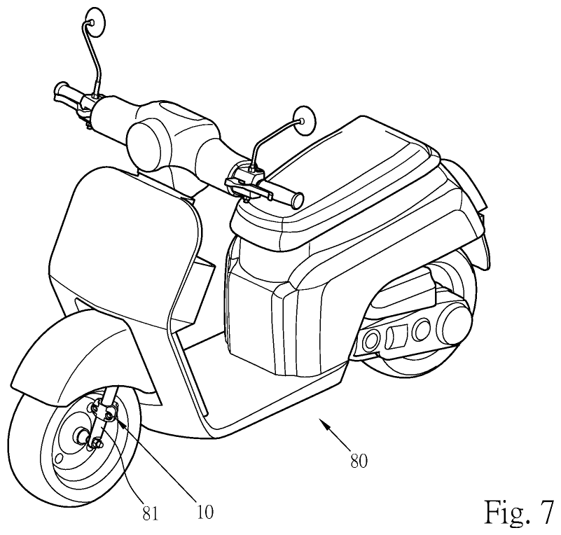

As shown in FIG. 6, the tracking element protection device 10 can also accommodate a different type of tracking element 601 when the smart phone uses a different operation system. FIG. 7 shows that the tracking element protection device 10 is secured to the front suspension device 81 of a motorbike 80.

While we have shown and described the embodiment in accordance with the present invention, it should be clear to those skilled in the art that further embodiments may be made without departing from the scope of the present invention.

What is claimed is:

1. A tracking element protection device (10) comprising:
a first part (20) having a first recess (21) defined in an inside thereof for accommodating a tracking element therein, two ribs (23) respectively extending outward from two ends of the inside of the first part (20), each rib (23) including a threaded hole (25);
two clamp members (30, 301) shaped symmetrically to each other, each of the two clamp members (30, 301) including a groove (31) defined in an inside thereof so as to clamp a portion of a bicycle;
a second part (40) including a second recess (41) defined in an inside thereof, two through holes (43) defined through the second part (40), the second part (40) being mounted to the first part (20), the two clamp members (30, 301) located between the first and second parts (20, 40), the second recess (41) located corresponding to the first recess (21), the two through holes (43) located corresponding to the two threaded holes (25), and
two fasteners (50) respectively extending through the two through holes (43) of the second part (40) and being threadedly connected to the threaded holes (25) of the first part (20), each fastener (50) including a head (51) and a threaded shank (53) extending from the head (51), the threaded shank (53) extending through the through hole (43) and threadedly connected to the threaded hole (25) corresponding thereto, the head (51) of each fastener (50) being a semi-sphere head which includes at least three first positioning portions (52) spaced apart from each other, the three first positioning portions (52) being located not symmetrical to each other.

2. The tracking element protection device as claimed in claim 1 further comprising a key (55) that includes a chamber (551) formed in one end thereof, at least three second positioning portions (56) formed to an inner periphery of the chamber (551), the head (51) of each fastener (50) being accommodated in the chamber (551) of the key (55), the at least three first positioning portions (52) and the at least three second positioning portions (56) being engaged with each other, the key (55) being rotated to rotate the fastener (50) such that the second part (40) is separated from the first part (20).

3. The tracking element protection device as claimed in claim 1, wherein the first part (20) includes two flanges (22) formed between the two ribs (23), the first recess (21) is formed between the two flanges (22) and the two ribs (23), each first flange (22) includes a notch (221) which communicates with the first recess (21), each rib (23) includes a plug (24) received therein and the threaded hole (25) is located at a center of the plug (24).

4. The tracking element protection device as claimed in claim 1, wherein each of the two clamp members (30, 301) includes two ridges (32) respectively extending outward from two sides thereof.

5. The tracking element protection device as claimed in claim 1, wherein the second part (40) includes two arms (42) respectively extending from two sides thereof and toward the first part (20), the two arms (42) are mounted to two respective outsides of the two ribs (23) when the first and second parts (20, 40) are connected to each other.
